(19) United States
(12) Patent Application Publication
(10) Pub. No.: US 2006/0189231 A1
(43) Pub. Date: Aug. 24, 2006

(54) Reinforced polyurethane foam and its manufacturing process

(76) Inventors: Meng-Fong Shieh, Tainan Hsien (TW); Meng-Dar Shieh, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/062,813

(22) Filed: Feb. 23, 2005

(51) Int. Cl. B29C 44/12; B32B 5/24; B29C 67/00; B32B 17/02

(52) U.S. Cl. 442/30; 264/46.4; 442/180; 442/221

(57) ABSTRACT

A reinforced polyurethane foam and its manufacturing process; an interface layer being sandwiched by the polyurethane foam and a fiberglass reinforcement layer by having polyurethane consistently coated on each part of a silicone rubber mold; immediately followed with the installation of the interface layer on the polyurethane; the polyurethane then allowed to be foamed and molded before coating on the interface layer a well mixed base polyester and hardener; the fiberglass layer then bound thereon; and finally the coating of a well mixed surface polyester and a hardener on the fiberglass layer.

### BACKGROUND OF THE INVENTION

(a) Field of the Invention

The present invention relates to reinforced polyurethane foam and its manufacturing process, and more particularly, to a laminated construction of having an interface layer sandwiched by the polyurethane foam and a fiberglass reinforcement layer, and its manufacturing process.

(b) Description of the Prior Art

Though the polyurethane foam is light and can be easily molded for production, it yields comparatively poor strength and is vulnerable to break up when subject to excessive force externally provided.

Fiberglass Reinforced Plastics(FRP) is usually applied for reinforced plastic materials. Polyester and hardener must be added into FRP to be well blended before adding into fiberglass for lamination process.

However, after the direct molding of the FRP layer on the polyurethane foam either after or in the course of the polyurethane foaming process, the FRP tends to be stripped off to offer a reinforced construction after the molding.

In practice, polyurethane foam is commonly applied in a large decoration pot. The surface of the hollow polyurethane foam pot is usually covered with rough decoration pattern. Conventionally, a silicone rubber mold in conjunction with an inner mold is used to cast the hollow polyurethane foam pot. In production, the silicone rubber mold is closed up with its inner mold before pouring into polyurethane. When molded, the polyurethane foam is stripped off manually and slowly its silicone rubber mold to remove the polyurethane foam pot.

When loaded with larger plant or water, the polyurethane foam pot easily gets broken up due to its poor strength to prevent duration life cycle.

Furthermore, although it is possible to have FRP directly molded in the polyurethane foam pot, but when the polyurethane foam pot is loaded with larger plant or water, the FRP layer would detach from the polyurethane foam pot easily.

### SUMMARY OF THE INVENTION

The primary purpose of the present invention is to provide reinforced polyurethane foam and its manufacturing process. Wherein, an interface layer is sandwiched between the polyurethane foam and a fiberglass reinforcement layer for the reinforced polyurethane foam has one side made of polyurethane foam and the other side made of fiberglass reinforcement. The improvement of the invention is to utilize the durable impact of the polyurethane foam and the reinforced structure of the fiberglass reinforcement layer. The manufacturing process of the present invention comprises having the polyurethane material fully and consistently applied on the silicone rubber mold and immediately mount an interface layer on polyurethane. Once foamed, a base polyester and hardener mixture is mixed well and applied on the interface layer, followed with a layer of fiberglass, and coated thereon a mixture prepared by well mixed surface polyester and hardener.

### BRIEF DESCRIPTION OF THE DRAWINGS

FIG. 1 is a schematic view of a construction of the present invention.

FIG. 2 is a schematic view showing a construction of the present invention applied in a hollow pot.

FIG. 3 is a schematic view showing a construction of the present invention applied in a helmet.

FIG. 4 is a schematic view showing a construction of the present invention applied in an icebox/briefcase.

FIG. 5 is a schematic view showing a construction of the present invention applied in a decoration item/board.

FIG. 6 is a schematic view showing a manufacturing process of the present invention.

### DETAILED DESCRIPTION OF THE PREFERRED EMBODIMENTS

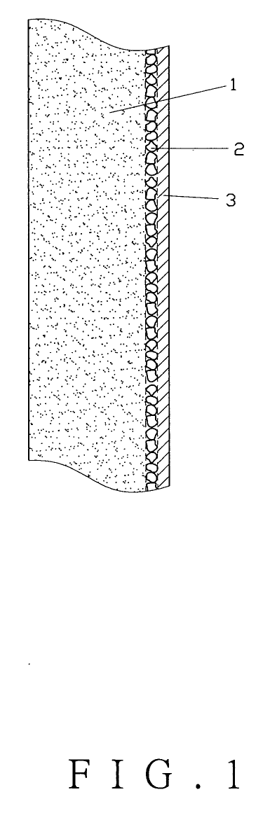

Referring to FIG. 1 for a schematic view of a construction of the present invention, one side of a polyurethane foam (1) is provided with an interface layer (2) installed thereon a fiberglass reinforcement layer (3) to define a laminated construction having the interface layer (2) sandwiched by the polyurethane foam (1) and the fiberglass reinforcement layer (3). Accordingly, one side of the reinforced polyurethane foam (1) is provided with polyurethane foam and the other side is provided with the fiberglass reinforcement layer (3). Wherein, the surface of the interface layer (2) is roughened in the form of grains comprised of calcium carbonate powders with each in the size not smaller than 200-mesh. The interface layer may be comprised of particles including but not limited to calcium carbonate powder, titanium dioxide powder and sand powder in a grain size larger than 200-mesh preferred since any larger size means better binding force. Alternatively, the interface layer may be a mesh including but not limited to a gauze or fabric.

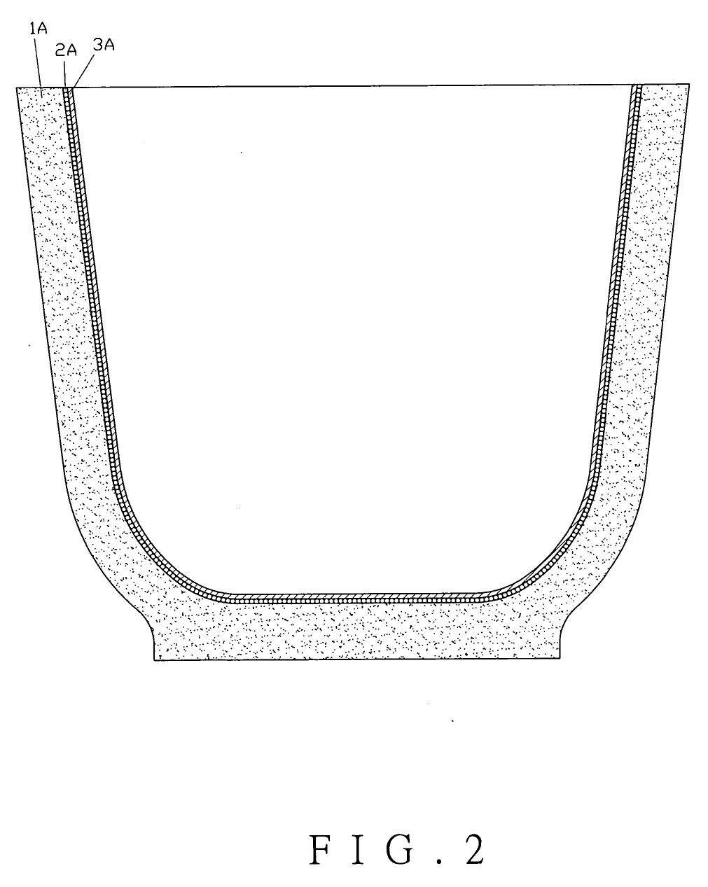

FIG. 2 shows that the present invention is applied in a hollow polyurethane foam pot (1A) having roughened pattern on its outer side while an interface layer (2A) and a fiberglass reinforcement layer (3A) are installed on the inner side of the polyurethane foam pot (1A).

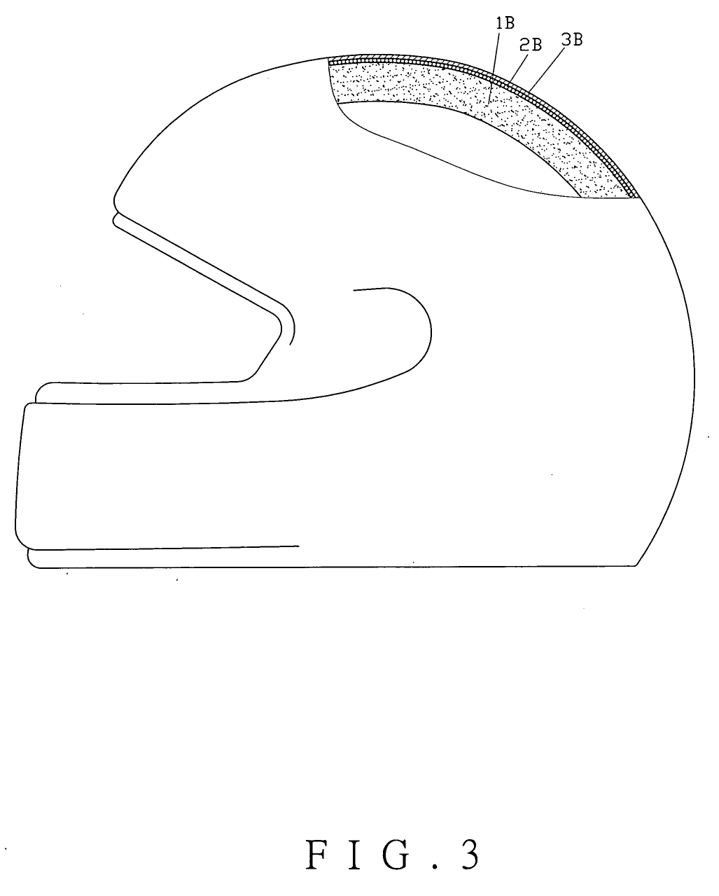

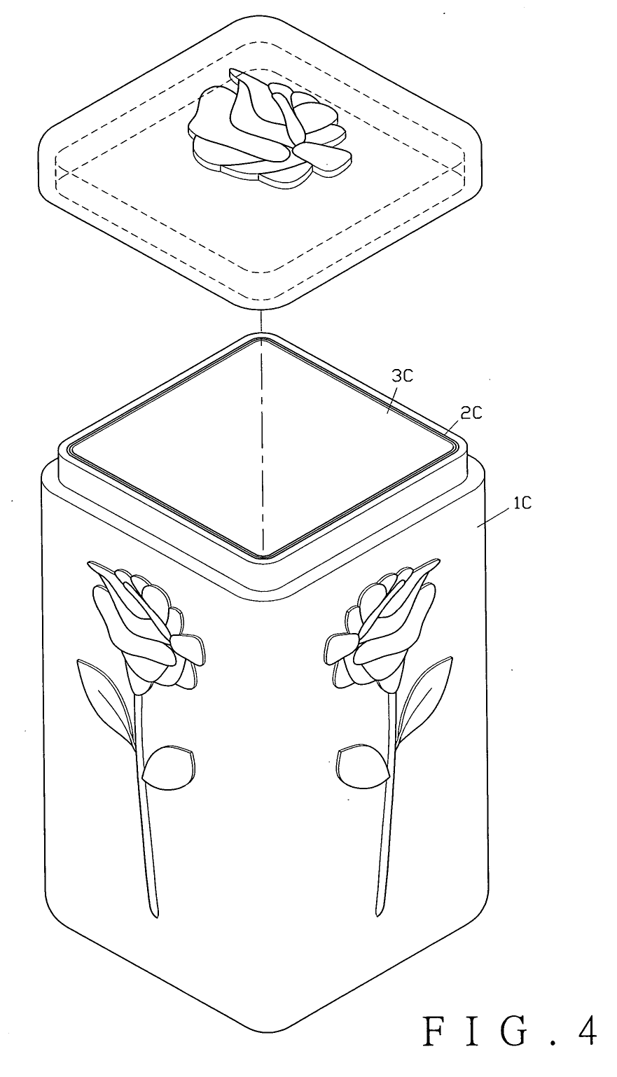

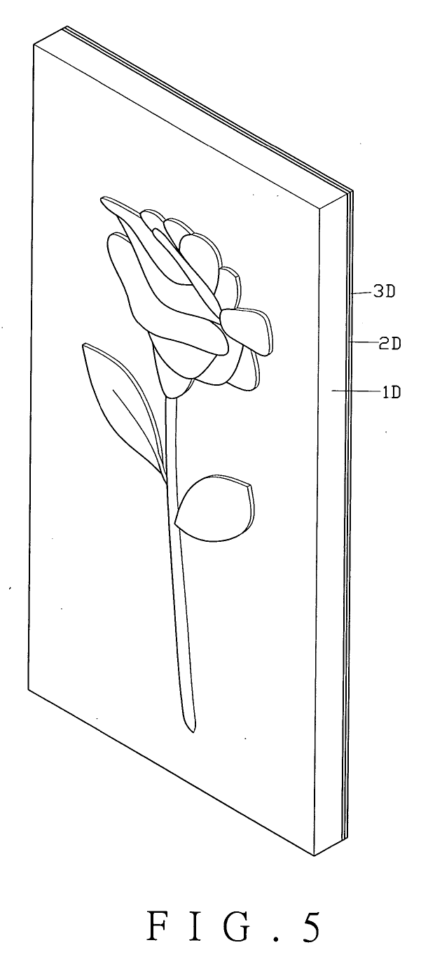

The present invention may be applied in a helmet as illustrated in FIG. 3. Wherein, an interface layer (2B) and a fiberglass reinforcement layer (3B) are provided on the outer side of a polyurethane foam (1B). Similarly, as illustrated in FIG. 4, the present invention is applied in an icebox (or a briefcase). Wherein, both of an interface layer (2C) and a fiberglass reinforcement layer (3C) are provided on the inner side of a polyurethane foam (1C) having a soft surface or provided with versatile patterns to yield better hand touch and visual sensation. As illustrated in FIG. 5, the present invention is applied in a decoration item/board. Wherein one side of a polyurethane foam (1D) features a smooth or soft and flexible surface, or the surface is provided with decoration patterns while the other side of the polyurethane foam (1D) is a fiberglass reinforcement layer (3D) while an interface layer (2D) is sandwiched by the fiberglass reinforcement layer (3D) and the polyurethane foam (1D).

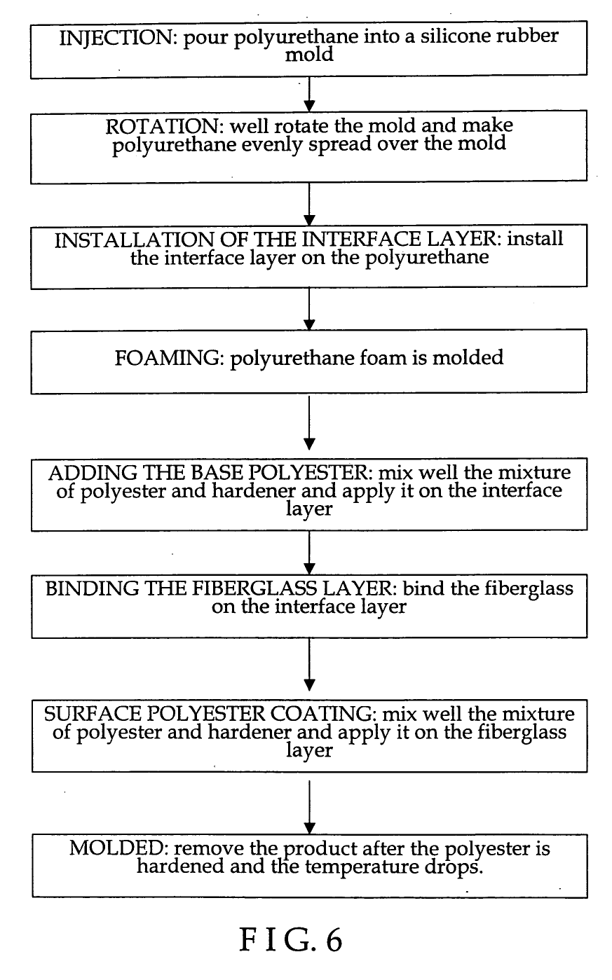

The manufacturing process of the reinforced polyurethane foam as exampled by the present invention in the manufacturing of a foam pot involves having first the polyurethane injected into a silicone rubber mold and fully and consistently coated on the mold; followed immediately by mounting a course of an interface layer on the polyurethane; polyurethane foaming left molded; a well mixed mixture of a base polyester and a hardener then coated on the interface layer and then bound with a fiberglass reinforcement layer; and a well mixed mixture of a surface polyester and a hardener then coated on the fiberglass reinforcement layer in a process flow as illustrated in FIG. 6:
a. Injection: pour polyurethane into a silicone rubber mold.
b. Rotation: well rotate the mold and make polyurethane evenly spread over the mold.
c. Installation of the interface layer: fast cast on the polyurethane 200-mesh calcium carbonate powders.
d. Foaming: wait for four minutes for the polyurethane foaming and molded in shape.
e. Adding the base polyester: fetch proper amount of polyester and hardener and mix them well to manually brush the polyester on the interface layer installed on the inner side of the polyurethane foam pot.
f. Binding the fiberglass layer: fetch proper amount of fiberglass and hardener and mix them well to manually brush the mixture on the interface layer and bind the fiberglass layer on the interface layer.
g. Surface polyester coating: fetch proper amount of polyester and hardener and mix well to brush the mixture on the fiberglass layer.
h. Molded: wait for three minutes for the polyester to get hardened and the temperature drops before removing the finished product from the mold.

In Step c, the interface layer may be particles including but not limited to calcium carbonate powder, titanium dioxide powder or sand powder in a size larger than 200-mesh since larger size means better binding force. The interface layer may be a mesh including but not limited to a gauze and fabric.

What is claimed is:

1. A reinforced polyurethane foam comprising a polyurethane foam having on one side provided with an interface layer; a fiberglass reinforcement layer thereon with the interface layer sandwiched between the polyurethane foam and the fiberglass reinforcement layer.

2. The reinforced polyurethane foam of claim 1, wherein the surface of the interface layer is roughened.

3. The reinforced polyurethane foam of claim 1, wherein the interface layer is comprised of particles.

4. The reinforced polyurethane foam of claim 3, wherein the particles are calcium carbonate, titanium dioxide or sand powders.

5. The reinforced polyurethane foam of claim 1, wherein the interface layer is a mesh.

6. A reinforced polyurethane foam pot comprising an interface layer provided on an inner side of the polyurethane foam pot; a fiberglass reinforcement layer thereon with the interface layer sandwiched between the polyurethane foam pot and the fiberglass reinforcement layer.

7. The reinforced polyurethane foam pot of claim 6, wherein the surface of the interface layer is roughened.

8. The reinforced polyurethane foam pot of claim 6, wherein the interface layer is comprised of particles.

9. The reinforced polyurethane foam pot of claim 8, wherein the particles are calcium carbonate, titanium dioxide or sand powders.

10. The reinforced polyurethane foam pot of claim 6, wherein the interface layer is a mesh.

11. A reinforced polyurethane foam manufacturing process comprising having consistently coated polyurethane on a mold, immediately followed with the installation of an interface layer on the polyurethane; the polyurethane being foamed and molded; a well mixed base polyester and hardener then coated on the interface layer before binding thereon a fiberglass layer; and finally coated on the fiberglass layer a well mixed surface polyester and hardener.

12. The reinforced polyurethane foam manufacturing process of claim 11, wherein the surface of the interface layer is roughened.

13. The reinforced polyurethane foam manufacturing process of claim 11, wherein the interface layer is comprised of particles.

14. The reinforced polyurethane foam manufacturing process of claim 13, wherein the particles are calcium carbonate, titanium dioxide or sand powders.

15. The reinforced polyurethane foam manufacturing process of claim 11, wherein the interface layer is a mesh.

16. A manufacturing process for a reinforced polyurethane foam pot comprising having polyurethane consistently coated on each part of a silicone rubber mold; immediately followed with the installation of an interface layer on the polyurethane; the polyurethane being foamed and molded; the interface layer then coated with a mixture of base polyester and hardener well mixed before the installation of a fiberglass layer; and the fiberglass layer coated with a well mixed surface polyester and hardener.

17. The manufacturing process for a reinforced polyurethane foam pot of claim 16, wherein the surface of the interface layer is roughened.

18. The manufacturing process for a reinforced polyurethane foam pot of claim 16, wherein the interface layer is comprised of particles.

19. The manufacturing process for a reinforced polyurethane foam pot of claim 18, wherein the particles are calcium carbonate, titanium dioxide or sand powders.

20. The manufacturing process for a reinforced polyurethane foam pot of claim 16, wherein the interface layer is a mesh.
